(19) United States
(12) Patent Application Publication
(10) Pub. No.: US 2010/0106971 A1
(43) Pub. Date: Apr. 29, 2010

(54) METHOD AND COMMUNICATION SYSTEM FOR PROTECTING AN AUTHENTICATION CONNECTION

(76) Inventor: DOMAGOJ PREMEC, Zagreb (HR)

Correspondence Address: Brake Hughes Bellermann LLP;c/o Intellevate, P.O. Box 52050, Minneapolis, MN, 55402, US

(21) Appl. No.: 12/259,269

(22) Filed: Oct. 27, 2008

(51) Int. Cl. H04L 9/00

(52) U.S. Cl. 713/171

(57) ABSTRACT

A method for protecting an authentication connection is described, comprising generating a first keying material by generating a first authentication connection, deriving from the generated first keying material a second keying material and utilizing the second keying material for protecting a second authentication connection.

### TECHNICAL FIELD OF THE INVENTION

The present invention relates to the technical field of communication networks. In particular the present invention relates to a method for protecting an authentication connection, a method for generating a keying material in a Mobile Gateway apparatus, a method for generating a keying material in a Master apparatus, a computer-readable medium, a communication system, a Mobile Gateway apparatus, and a Master apparatus.

### BACKGROUND OF THE INVENTION

In a multiple host scenario for a WiMAX™ scenario a WiMAX™ station may exist, the so-called Gateway Mobile Station (G-MS), which may be equipped with additional network interfaces. These additional network interfaces may allow to connect hosts or G-hosts to a G-MS. Thus, the G-hosts may be end user devices which may be connected to the network via a G-MS. In other words, the G-MS may be a mobile access device or a mobile gateway device which may allow a plurality of different mobile stations, MS, or hosts to link to a network. The additional interfaces of the G-MS may base on an IEEE 802.11 standard or may base on an IEEE 802.3 standard. Thus, a G-MS at the same time may be an IEEE 802.11 access point and/or a IEEE 802.3 switch or an IEEE 802.3 bridge. Other interface technologies may also be possible.

Computers or hosts, which in the context of multiple host feature may be called the G-hosts, may attach to the WiMAX™ network through the G-MS for providing access to the WiMAX™ network, the G-MS may have a WiMAX™ connection to backhaul the traffic of the G-hosts to the G-MS.

If a G-host may use an IEEE 802.11 interface to connect to the G-MS, the G-MS may be acting as an IEEE 802.11 access point towards the G-host. Since the G-MS may only provide physical access to the network each G-host may have to have an individual WiMAX™ subscription, i.e. the G-host may need to be authorized to access the network of a Network Service Provider.

Since the G-MS may also be a mobile station the G-MS may also roam in an area of a WiMAX™ network. While roaming, the access to the WiMAX™ network for the G-MS may change due to possible handoffs in the WiMAX™ access network.

In the document WiMAX™ Forum Network Architecture, “Stage 2: Architecture tenets, reference model and reference points”, part 3—informative annex, release 1.0.0, Mar. 28, 2007, of the WiMAX™ Forum, different deployment scenarios are disclosed.

In the document WiMAX™ Forum network architecture, “Stage 3: Detailed protocols and procedures”, release 1.0.0, Mar. 28, 2007, from the WiMAX™ Forum, deriving of keys from MSK and EMSK is described.

The document NWG_Nortel_MultipleHosts_stage2, a contribution to the WiMAX™ Forum network working group, no. 060110, 01.10.2006, describes a multiple host support.

Furthermore, from the document NWG Siemens Multiple Hosts_R1, no. 051219, December 2005, issues of multiple hosts behind a MS (Mobile Station) are known.

From the document, RFC 2865 (request for comment), “Remote Authentication Dial In User Service (RADIUS)”, of June 2000, a RADIUS protocol is known.

The document, RFC 2868, “RADIUS Attributes for Tunnel Protocol Support”, of June 2000, defines a set of RADIUS attributes designed to support the provision of compulsory tunnelling in dial-up networks.

The document, RFC 3579, “RADIUS (Remote Authentication Dial In User Service) Support For Extensible Authentication Protocol (EAP)”, of June 2003, defines a framework which supports multiple authentication mechanisms.

There may be a need for providing to more effectively protect an authentication connection.

### SUMMARY OF THE INVENTION

According to an exemplary embodiment of the present invention, a method for protecting an authentication connection, a method for generating a keying material in a Mobile Gateway apparatus, a method for generating a keying material in a Master apparatus, a computer-readable medium, a communication system, a Mobile Gateway apparatus and a Master apparatus may be provided.

According to an exemplary embodiment of the present invention, a method for protecting an authentication connection may comprise generating a first keying material by generating a first authentication connection or a first authentication association. In an example the method may also comprise deriving from the generated keying material, a second keying material and utilizing the second keying material for protecting a second authentication connection or a second authentication association.

According to another exemplary embodiment of the present invention, a method for generating a keying material in a Mobile Gateway apparatus may be provided. The method for generating a keying material may comprise authenticating the Mobile Gateway apparatus at a Master apparatus by generating a first authentication connection, e.g. by utilizing a first authentication method. In an example, the method may further comprise generating a first keying material during authenticating the Mobile Gateway apparatus in the Master apparatus.

Furthermore, in an example, the method for generating a keying material in a Mobile Gateway apparatus may comprise deriving in the Mobile Gateway apparatus from the generated first keying material, a second keying material for utilizing the keying material in a second authentication connection or in a second authentication method and utilizing the second keying material in the second authentication connection.

According to another exemplary embodiment of the present invention, a method for generating a keying material in a Master apparatus may be provided, wherein the method for generating a keying material may comprise authenticating a Mobile Gateway apparatus in the Master apparatus by generating a first authentication connection with the Mobile Gateway apparatus.

In an example, the method for generating a keying material in a Master apparatus may also comprise generating a first keying material during authenticating the Mobile Gateway apparatus in the Master apparatus and deriving from the first keying material, a second keying material for utilizing the second keying material in a second authentication connection. The method may further comprise utilizing the second keying material in a second authentication connection. The second authentication connection may be established utilizing a second authentication method.

In another example, the first authentication connection and the second authentication connection may base on different authentication protocols, e.g. EAP and/or RADIUS.

According to another exemplary embodiment of the present invention, a computer-readable medium may be provided, wherein the computer-readable medium may comprise a computer program, which may be adapted, when being executed by a processor, to carry out at least one method selected from the group of methods consisting of the method for protecting an authentication connection, the method for generating a keying material in a Mobile Gateway apparatus, the method for generating a keying material in a Master apparatus.

A computer-readable medium may be a floppy disk, a hard disk, an USB (Universal Serial Bus) storage device, a RAM (Random Access Memory), a ROM (read only memory) and an EPROM (Erasable Programmable Read Only Memory). A computer readable medium may also be a data communication network, e.g. the Internet, which may allow downloading a program code.

According to another exemplary embodiment of the present invention, a program element may be provided, wherein the program element may be adapted, when being executed by a processor, to carry out at least one method selected from the group of methods consisting of the method for protecting an authentication connection, the method for generating a keying material in a Mobile Gateway apparatus, the method for generating a keying material in a Master apparatus.

According to yet another exemplary embodiment of the present invention, a communication system may be provided, wherein the communication system may comprise a Mobile Gateway apparatus and a Master apparatus.

In an example, the Mobile Gateway apparatus and the Master apparatus may be adapted for generating a first keying material by using a first authentication connection for authenticating the Mobile Gateway apparatus in the Master apparatus.

Furthermore, in an example, the Master apparatus and the Mobile Gateway apparatus may be each adapted for deriving from the generated first keying material, a second keying material and utilizing by the Mobile Gateway apparatus and by the Master apparatus a corresponding second keying material in a second authentication connection.

According to yet another exemplary embodiment of the present invention, a Mobile Gateway apparatus may be provided, wherein the Mobile Gateway apparatus may comprise a first Authentication device, a second Authentication device and a Keying Material Generation device.

In an example, the first Authentication device may be adapted for authenticating the Mobile Gateway apparatus with a Master apparatus by utilizing a first authentication connection.

In an example, the Keying Material Generation device may be adapted for utilizing the first keying material of the first authentication connection for deriving a second keying material.

In a further example the second Authentication device may also be adapted for utilizing the second keying material for a second authentication connection.

According to another exemplary embodiment of the present invention, a Master apparatus may be provided, wherein the Master apparatus may comprise an Authenticating device and a Keying Material Generation device.

In an example, the Authenticating device of the Master apparatus may be adapted for authenticating a Mobile Gateway apparatus in a first authentication connection and for generating a first keying material.

In a further example, the Keying Material Generation device of the Master apparatus may be adapted for utilizing the first keying material of the first authentication connection for deriving a second keying material.

The Mobile Gateway apparatus may provide access for a plurality of Host devices, hosts or G-hosts. The G-hosts may authenticate with a Master apparatus using a first authentication method or a first authentication process.

The same first authentication method may also be used by the Mobile Gateway apparatus to authenticate with the Master apparatus. Thus, a multiple host access may be provided.

Using an authentication method may mean establishing an authentication connection utilizing an authentication method, wherein the authentication method may be conducted according to a corresponding authentication protocol. Examples for authentication protocols may be EAP, RADIUS or PKI (Public Key Infrastructure).

The Mobile Gateway apparatus may be a Gateway Mobile Station (G-MS). The Master apparatus may be a Home AAA server (Home Authentication Authorization and Accounting server) or H-AAA server. In an example a Proxy Relay apparatus, e.g. an Access Serving Network Gateway (ASN GW) comprising an AAA proxy or an AAA proxy, may act on behalf of the H-AAA server. In other words, the ASN GW may forward or relay a AAA message to the corresponding H-AAA server.

When connecting to a network, the G-MS may connect to the network in substantially the same way as a G-host. I.e. the G-MS may use the same protocol or the same method for connecting to the network as a G-host. When connecting to the network, a host and/or a G-MS may need to be authenticated with the network and thus, the host and/or the G-MS may establish a first authentication connection with the network. An authentication connection may be established by utilizing a corresponding authentication method.

In a particular example a first authentication method may be utilized for establishing a first authentication connection. Such a first authentication method may base on the EAP (Extensible Authentication Method) authentication protocol.

Since a G-host for example may connect or attach to a network via the G-MS, the G-host may expect to use EAP as an authentication method with the G-MS. Thus, the G-host may have the role of an EAP supplicant and the G-MS may have the role of an EAP authenticator.

The authentication context or subscription context, such as access rights, subscription level or user name and password may be located in a H-AAA server of a Network Service Provider (NSP). This subscription context of a G-host may be only accessed by using a predefined authentication method, a second authentication connection or a second authentication method, e.g. RADIUS. The first access method and the second access method may be different. Thus, the first authentication connection and the second authentication connection may also be different.

However, the second authentication connection may require a particular protection mechanism. In an example, the RADIUS connection between a G-MS and a AAA proxy may be protected by utilizing a Message-Authenticator attribute defined in the RADIUS protocol. The Message-Authenticator attribute may assume that a shared secret may exist between the communicating parties, i.e. between G-MS and AAA proxy. In other words, the G-MS and the AAA proxy may need identical keying material or an identical value for establishing the second authentication connection.

Dynamically deriving a RADIUS shared secret for a connection between a Mobile Gateway apparatus and a Proxy Relay apparatus may allow providing a shared secret at different locations. In other words, keying material generated during establishing a first authentication connection, i.e. an authentication of the G-MS and a corresponding H-AAA server belonging to a corresponding G-host, may be utilized to generate keying material or to generate a shared secret used to protect and authenticate RADIUS messages exchanged between the G-MS and the AAA proxy function or Proxy Relay apparatus during the authentication of a G-host.

In other words, the end-to-end connection between G-host and H-AAA server may comprise several ‘legs’, several links or several connections.

One of the ‘legs’, i.e. the RADIUS ‘leg’, may exist or may be established between G-MS and the AAA proxy function or between G-MS and the AAA proxy.

A further ‘leg’ may be established between the AAA proxy function and the next AAA proxy server.

Another ‘leg’ may be established between the H-AAA or the H-AAA server and the AAA proxy, wherein the AAA proxy may be directly connected to the H-AAA.

In the following the first ‘leg’ or the RADIUS ‘leg’ is described, i.e. the connection between the G-MS and the AAA proxy in the ASN, to which AAA proxy the G-MS talks.

Each G-host may have a separate H-AAA server, though many G-hosts may share the same H-AAA server.

In a particular example, each G-host may have a different H-AAA server. The shared secret may only be used to protect the RADIUS connection between the G-MS and the AAA proxy in the ASN. The G-MS may use the same key to protect by means of RADIUS the messages, which the G-MS may receive from each of the G-hosts that are attached to the G-MS, regardless of the G-host's H-AAA server.

An authentication connection between the G-MS and the H-AAA server may be comparable to an authentication connection between the G-MS and a AAA proxy or a Relay apparatus. The AAA proxy may be adapted to forward received messages belonging to an authentication connection to the corresponding H-AAA server.

Both, the G-MS and H-AAA server independently may generate the same first keying material and may use the generated first keying material to derive a shared secret for the second authentication connection, i.e. for the RADIUS connection, the RADIUS ‘leg’ or for protecting RADIUS messages belonging to a RADIUS connection. In other words, the EMSK may not be used directly or as it may be; instead an additional key may be derived from the EMSK.

In this context independently may mean that both the MS and the H-AAA generate the EMSK on their own during the authentication of the MS, and the rules for generating EMSK are such that both the MS and the H-AAA come up with the same value for the EMSK. So, although the G-MS and the H-AAA may have not exchanged a key or a message, at the end of the authentication process both the MS and the H-AAA may be in possession of a secret number (EMSK) known only to them.

Once a RADIUS connection or a RADIUS tunnel may have been established using a RADIUS authentication method, this RADIUS connection may be utilized for transporting authentication context for a single host.

RADIUS may not be a connection oriented protocol and connection establishment or connection tear down procedures may not exist in RADIUS. Therefore, in this context the term ‘RADIUS connection’ may be used to indicate that a pair of RADIUS entities, peers or apparatuses may exist which use the RADIUS protocol to talk to each other and which entities may be associated to one another by using a shared secret. Thus, in the context of this text the term ‘RADIUS connection’ may refer to a state between a pair of RADIUS entities where the IP address of a corresponding RADIUS peer entity and the associated shared secret may be known to each peer entity. Thus, a connection may be an association between at least two peers.

The same principle may be applicable for an EAP connection.

For a successful ‘RADIUS connection’ or RADIUS association, both entities may have to know the IP address of the peer and the shared secret, which may be used to protect the messages.

The G-MS may set up to every G-host, which may connect via the G-MS to a corresponding NSP, an EAP connection between the G-MS and the G-host. But, the G-MS may use a single RADIUS connection to the AAA proxy for providing backhaul transport for the G-host authentication context. The G-MS may comprise an authenticator or may be the authenticator for a G-host. The authenticator for the G-MS however, may be collocated with the AAA proxy.

Thus, by using the association, the leg or the RADIUS ‘leg’ between the G-MS and the AAA proxy the G-MS may always only talk to the AAA proxy in the ASN. Since the RADIUS messages, which may be sent by the G-MS or by the RADIUS client on the G-MS to the AAA proxy in the ASN, may be relayed by the AAA proxy to the H-AAA server of the corresponding G-host, the G-MS may not know or may not care about the content of the message and what may happen to the message in the AAA proxy. Therefore, the G-MS may provide the service of a transparent secure transport between the G-MS and the corresponding AAA proxy. The AAA proxy function or the AAA proxy may not be specific to a G-host. The G-MS may use the same AAA proxy function for all G-hosts.

The RADIUS connection may be a transport connection protected by using the RADIUS protocol for substantially securely exchanging the messages between the G-MS and the AAA proxy related to authentication of the G-host.

The G-MS may become the authenticator for a G-host in the sense of an EAP authenticator. In other words, a G-host may use the EAP protocol to communicate with the G-MS and to send the message, which the G-MS may transfer via the AAA proxy to the H-AAA server, belonging to the G-host. Thus, in the case of using EAP between G-host and G-MS and RADIUS between G-MS and AAA proxy, the G-host may still be authenticated by the H-AAA server, despite the fact that the host talks to an entity called authenticator in the form of the G-MS. Thus, EAP authenticator may be a name from one peer of an EAP relation and may not mean that the EAP authenticator authenticate the G-host.

According to a further exemplary embodiment of the present invention, the method for protecting an authentication connection may further comprise deriving dynamically the second keying material.

The method for protecting an authentication connection may be used in a mobile network and as a consequence of the mobility may amendments concerning the arrangement of the network appear. For example, by moving a Gateway MS, a G-MS or a Mobile Gateway apparatus within the network a re-authentication may be required. Re-authentication may generate new first keying material and in order to have up to date second keying material dynamically deriving the second keying material from the first keying material may help to update the information.

In an other example the lifetime of the first keying material and/or the second keying material may have expired and may have become invalid. Thus, re-authentication may allow to renew the keying material and maintaining an established authentication connection.

According to another exemplary embodiment of the present invention, the first authentication connection may base on an Extensible Authentication Protocol (EAP).

EAP may be an authentication protocol which may be combined with another authentication method and therefore, the EAP method may be used as a first authentication method.

According to another exemplary embodiment of the present invention, the second authentication connection may base on a Remote Authentication Dial In User Service (RADIUS) protocol.

A Mobile Gateway apparatus or a G-MS may comprise a RADIUS client and therefore a G-MS may be able to use a RADIUS protocol when authenticating G-hosts with an access network. In other words, during the authentication of the G-MS with the H-AAA server belonging to the G-MS EAP may be used. For authenticating a G-host with the H-AAA server belonging to the G-host, the G-MS may use RADIUS to transport authentication messages between the G-MS and the corresponding H-AAA server belonging to the host.

A G-MS may also have the prerequisites for using an EAP authentication with the network and therefore combining EAP with RADIUS may help to generate a keying material that can be used in a mobile communication environment.

According to yet another exemplary embodiment of the present invention, generating a first keying material may comprise generating the first keying material in a Mobile Gateway apparatus and/or generating the first keying material in a Master apparatus.

An authentication connection which shall be protected may be located between a Mobile Gateway apparatus and a Master apparatus. For a secure authentication connection the endpoints of the second connection, i.e. the Mobile Gateway apparatus and the Master Apparatus or the Mobile Gateway apparatus and a Proxy Relay apparatus, may require the same keying material. Since there my not exist a secure connection between the endpoints, transporting a keying material from one endpoint to the other may not be possible. In one example the keying material may be preconfigured. Thus, transporting the keying material may be prevented. However, pre-configuring may mean additional effort and may not be scalable.

Therefore, generating the first keying material at the endpoints of the second authentication connection, which may require the keying material, may allow to have the keying material at a location where the keying material may be needed. Transporting of the keying material or pre-configuring of the keying material may be prevented.

According to another exemplary embodiment of the present invention, generating a first keying material may comprise generating a Master Session Key (MSK) and/or an Extended Master Session Key (EMSK).

MSK and EMSK may be a keying material which be generated for authenticating a Mobile Gateway apparatus at the location of the Mobile Gateway apparatus and a corresponding authenticator. The Mobile Gateway apparatus and the authenticator may be endpoints of a first authentication connection. Therefore, using the MSK and/or the EMSK may allow using an already generated keying material at endpoints of a first authentication connection for protecting a second authentication connection.

The MSK and/or the EMSK may be identical for a Mobile Gateway apparatus and/or for the authenticator. The authenticator may be collocated with the Master apparatus and/or with the Proxy Relay apparatus. Therefore, the MSK and/or the EMSK may be used within the G-MS and/or within the Master apparatus and/or the Proxy Relay.

According to another exemplary embodiment of the present invention, generating a second keying material may comprise calculating a shared secret in a Mobile Gateway apparatus and/or in a Master apparatus.

A shared secret may be a keying material used in a RADIUS apparatus or in endpoints of a RADIUS connection, e.g. a Mobile Gateway apparatus and/or a Master apparatus. Therefore, generating the shared secret in a Mobile Gateway apparatus and in a Master apparatus may allow to protect an authentication connection between the Mobile Gateway apparatus and the Master apparatus.

According to yet another exemplary embodiment of the present invention, the method for protecting an authentication connection may further comprise providing the second keying material to a Proxy Relay apparatus.

Providing the second keying material to a Proxy Relay apparatus may allow to transport a keying material to a location where the keying material may be used. The generated first keying material may stay at the Master apparatus.

According to another exemplary embodiment of the present invention, the method for generating a keying material in a Master apparatus may further comprise providing the second keying material to a Proxy Relay apparatus.

After receiving the second keying material in the Proxy Relay apparatus, the Proxy Relay apparatus may use the second keying material without having calculated the second keying material. The Proxy Relay apparatus may thus be used as an endpoint of the second authentication connection.

It has also to be noted that exemplary embodiments of the present invention and aspects of the invention have been described with reference to different subject-matters. In particular, some embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters in particular between features of the apparatus claims and the features of the method claims may be considered to be disclosed with this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows a block diagram of a communication system using a G-MS as a Gateway providing access to a network according to an exemplary embodiment of the present invention.

FIG. 2 shows a logical network diagram with different authentication connections according to an exemplary embodiment of the present invention.

FIG. 3 shows a block diagram of a Mobile Gateway apparatus according to an exemplary embodiment of the present invention.

FIG. 4 shows a block diagram of a Master apparatus according to an exemplary embodiment of the present invention.

### DETAILED DESCRIPTION

The illustration in the drawings is schematic. In different drawings, similar or identical elements are provided with the same reference numerals.

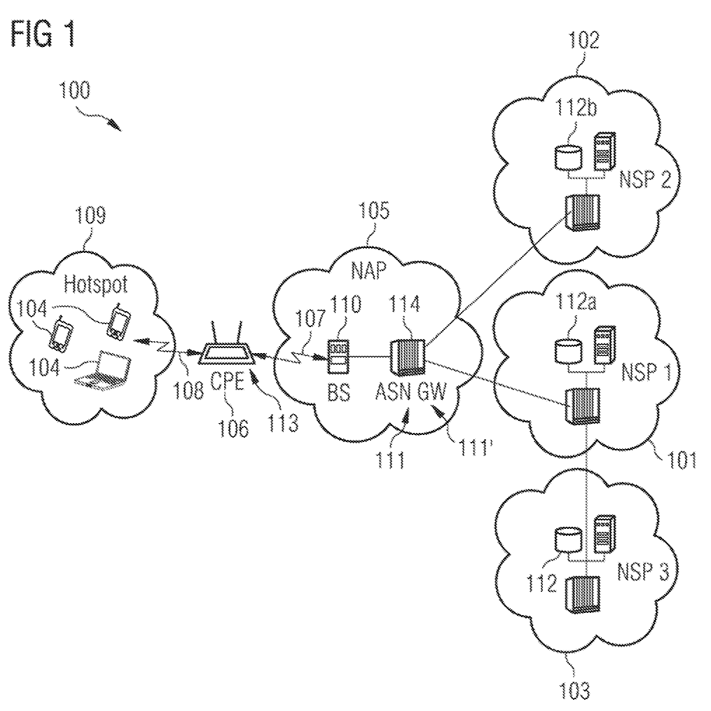

FIG. 1 shows a network system 100 or communication system 100 which is separated in a plurality of sub-networks. The network service providers 101, 102, 103, NSP1, NSP2, NSP3 offer services in a communication network. The services offered by the NSPs 101, 102, 103 may be value added services like Internet access, Voice over the Internet protocol (VoIP), Games etc. The NSPs 101, 102, 103 may not operate a network and thus, the NSPs 101, 102, 103 may receive traffic from their customer 104, user 104 or subscriber 104 via an Network Access Provider NAP, 105.

Since the NSPs 101, 102, 103 may have a contract with the subscriber 104, the service provider may verify before allowing the subscriber 104 to access the services of the NSP 101, 102, 103 whether the subscriber may be authorized using the services.

The subscriber 104 may use computers 104, MSs 104 or hosts 104, e.g. G-hosts 104 to attach to a network 105 wirelessly, e.g. the WiMAX network. For wireless network access the G-hosts 104 may connect through the G-MS 106 or wireless CPE (Customer Premise Equipment) 106. The G-MS 106 may use its WiMAX™ connection 107 to backhaul the G-hosts' 104 traffic. A G-host 104 may be a host having the multiple host feature, i.e. a G-host 104 may be adapted to connect to a G-MS 106 or Gatway Mobile Station 106. A G-host 104 may attach to the G-MS using the IEEE 802.11 technology. In that case the G-MS 106 may act as an IEEE 802.11 access point towards the G-hosts. Since the G-MS may have two wireless links 108, 107 the G-MS 106 may offer services wirelessly in a moving object. For example, the G-MS 106 may supplies a Hotspot 109 in a moving means of transportation.

Each of the G-hosts 104 may have a WiMAX™ subscription. This subscription may allow a G-host to access a core network, in particular the network of a NSP 101, 102, 103. The Network Access Provider NAP, 105 may collect in the Access network 105 the traffic of the G-hosts 104 and backhauls the collected traffic to the corresponding destinations 101, 102, 103.

For permitting wireless access the Access network 105 comprises the Base Station (BS) 110, which connects with the G-MS 106 via wireless link 107. For distributing the collected traffic to the various NSP 101, 102, 103, the access network comprise the ASN GW 114.

A hotspot 109 may be the area which a G-MS 106 covers, i.e. in which area the G-MS 106 may be able to provide connectivity. Each of the G-hosts 104 in a hotspot may be attached to the WiMAX™ network 105 through G-MS 106. Each G-host 104 may have a WiMAX™ subscription and may be separately authenticated to the network with their WiMAX™ subscription. Some hosts 104 may belong to a NSP (Network Service Provider) 101, 102, 103, which may not have a direct relationship with the NAP (Network Access Provider).

The subscriber authentication in WiMAX™ may be based on EAP (Extensible Authentication Method). When a WiMAX™ MS (Mobile Station) may attach to the network 105, the MS 106 may act as an EAP supplicant. An ASN GW (Access Serving Network Gateway) 114 of the NAP may act as an EAP authenticator. The AAA server 112 may be located in the subscriber's home CSN (Connectivity Serving Network) 101, 102, 103.

For authorization between G-host 104 and NSP 101, 102, 103 the Radius protocol is used. Thus, each of the G-hosts may be authenticated with the corresponding NSP 101, 102, 103.

For authentication purposes the G-MS 106 may be handled as a standard MS. Therefore, the G-MS 106 may be authenticated as any other MS. I.e. when the G-MS may attach to the network, the G-MS 106 may act a EAP supplicant and an ASN GW 114 in the network may act as the EAP authenticator.

In other words, the G-MS 106 may be an MS which may be connected to a network like a standard MS. However, the G-MS 106 may provide a plurality of interfaces 108 in order to provide access for at least one other MS 104. The G-MS 106 may have a interface 108 selected from the group of interfaces consisting of a Bluetooth interface, a WiMAX™ interface, an IEEE 802.11x interface, an IEEE 802.16x interface, an IEEE 802.3x interface. Thus, the G-MS may provide wire-bound and/or wireless interfaces. If one of the plurality of interfaces 108 is a wireless interface, a wireless hotspot may be provided.

When a WiMAX™ subscriber 104 may attach as a G-host 104 through the G-MS 106 the same EAP method and credentials may be used for authorizing the G-MS 106. During the authentication of the G-host 104, the G-host 104 may act as an EAP supplicant.

However, instead of the ASN GW 114, the G-MS 106 may act as an EAP authenticator for the G-host 104. An EAP authenticator may not need to be aware of the access parameter, such as credentials or password, of the host which has to be authenticated.

G-MS 106 also comprises a RADIUS client 113. The H-AAA 112 server of the G-host 104 is located in G-host's home CSN 103. The ASN GW 114 in the ASN 105 acts as an AAA proxy 111 with which the RADIUS client 113 in the G-MS 106 communicates during the authentication of the G-host 104. The protocol between G-MS 106 and AAA proxy 111 in the ASN is RADIUS. There may exist additional intermediary AAA proxies 111′ between the AAA proxy 111 in the ASN 105 and the home AAA server 112 in the home CSN 103.

The RADIUS client 113 in the G-MS 106 needs an IP address of the AAA proxy 111 in the ASN 105 for sending RADIUS messages during authentication of a G-host 104.

The G-MS may comprise a plurality of additional wireless interfaces and/or wirebound interfaces for attaching different G-hosts 104 to the G-MS 106. Each of the G-hosts 104 has a own WiMAX™ subscription.

The FIG. 1 illustrates the basic architecture. Each of the G-hosts 104 in the hotspot 109 is attached to the WiMAX™ network 105, 101, 102,103 through G-MS 106. Furthermore, each G-host is separately authenticated and/or authorized to/with the network 105, 101, 102,103 with its own WiMAX™ subscription.

Some hosts 104 might belong to different NSPs 101, 102, 103, i.e. each G-host may have a subscription with a different NSP 101, 102, 103. Not every NSP 101, 102, 103 has a direct relationship with the NAP.

The G-MS may not need to find out which G-host 104 is associated with which NSP. The G-MS may not need to know, to which NSP a particular G-host belongs; the G-MS sends EAP messages from a G-host using RADIUS to the AAA proxy, and AAA proxy takes care to dispatch the message towards the right H-AAA server.

The G-host 104 generates an EAP message and this EAP message is for example in a special IEEE 802.16 signalling message transmitted to the G-MS 106. The G-host 104 generally may not know the IP address of the G-host's H-AAA server 112b and the EAP message may not provide a field for a H-AAA address.

This mechanism may only be used for authentication, and not for other traffic/payload transport.

The G-MS 106 receives an EAP message from the G-host 104 and encapsulates the EAP message in a special field of a RADIUS Access Request message. The RADIUS Access Request message is generated by the G-MS 106 itself, and the EAP message received from the G-hosts 104 is carried as one field in the RADIUS message.

The G-host 104 provides the G-host's 104 NAI as part of the EAP message. Thus, the endpoints of the EAP protocol are the G-host 104 and the corresponding H-AAA server 112b. EAP messages may not be routable over the AAA infrastructure, thus the EAP messages are encapsulated in RADIUS messages and then the RADIUS based AAA infrastructure can take care of delivering the message to the correct recipient.

The AAA proxy 111 for example looks at the domain name part of the user NAI (Network Access Identifier), which is included within the message, and uses that domain name to locate the appropriate H-AAA server 112b.

The subscriber authentication in WiMAX™ is based on EAP. The same EAP method and credentials as used for authenticating a G-host 104 with a H-AAA server 112, 112a, 112b or with an AAA proxy 111 are also used when the WiMAX™ subscriber attaches as a G-host 104 through G-MS 106. However, the transport of the authentication messages may comprise the RADIUS connection between the G-MS 106 and the AAA proxy 111.

The protocol between G-MS 106 and AAA proxy 111 in the ASN 105 is RADIUS and all RADIUS messages exchanged between the G-MS 106 and the AAA proxy 111 in the ASN 105 may need to be protected with a Message-Authenticator attribute of a RADIUS packet.

The RADIUS Message-Authenticator attribute assumes that there is a shared secret between the communicating parties. A multi-host scenario is a scenario where a plurality of hosts access the network via one single access device, e.g. the G-MS 106. In the multi-host scenario this means that the G-MS 106 and AAA proxy 111 in the ASN 105 have a shared secret or that the G-MS 106 and the H-AAA 112 belonging to the G-MS have a shared secret.

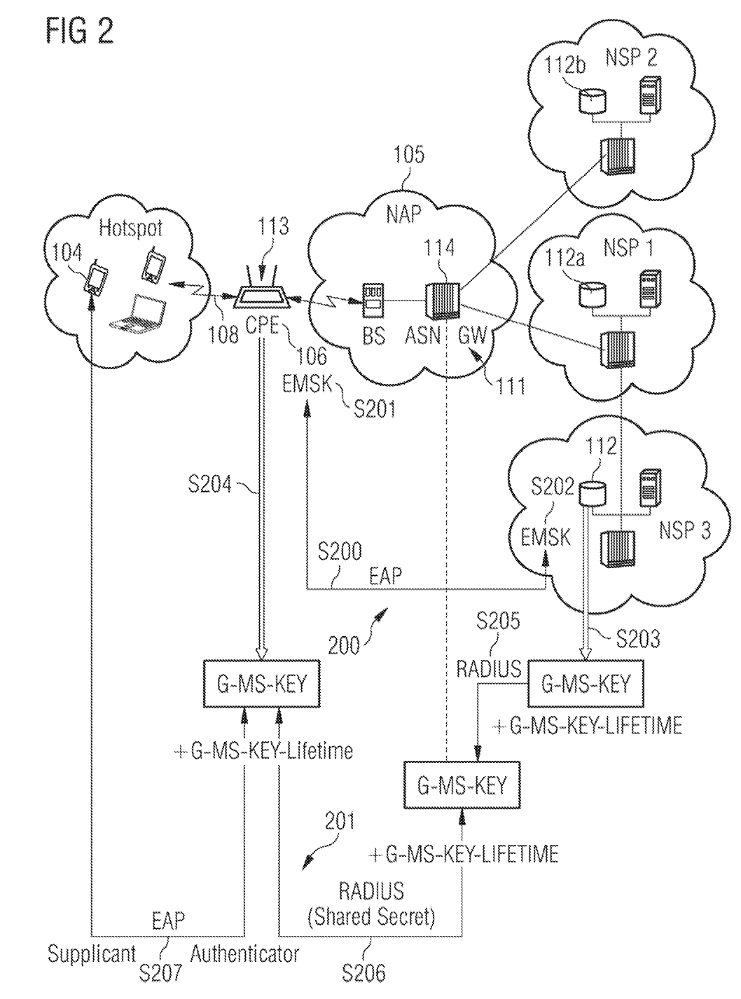

It may be seen as an aspect of the present invention to describe how a shared secret between the G-MS 106 and AAA proxy 111 (not shown in FIG. 2) can be established. A manual provisioning may be prevented. The method of establishing a shared sequence may be scalable. Thus, a plurality, e.g. thousands, of G-MS 106 nodes may be allowed to exist in a network configuration 100. By dynamically providing the shared secret, each of the G-MS 106 may be supplied with a shared secret.

If the G-MS 106 may move and thus connect to different AAA proxies 111 or different Proxy Relay apparatuses, it may be required that the G-MS 106 is provisioned with the secret keys of every AAA proxy 111 to which the G-MS 106 might connect. Since a plurality, hundreds or even thousands of AAA proxies 111 may exist in a network, a dynamic or automatic provisioning of the shared secrets may allow reducing the administrative effort. For provisioning secret keys or shared secrets.

The keys may have to be replaced on a regular basis. Since the keys are dynamically generated the manual replacement of keys may be prevented. Thus, the replacement of keys may not generate extra effort.

A manual installation of the keys or the keying material on every G-MS may be prevented. Thus, the G-MS may not have to be brought back to the operator to install a new key. Therefore, an out of service time or maintenance time for a G-MS may be reduced.

The use of certificates in order to protect RADIUS signalling between the G-MS 106 and the AAA proxy 111 may be prevented.

Furthermore, a protection with a Message-Authenticator attribute using a common secret shared by the peers may be possible.

A device authentication outside the ASN 105, e.g. outside the AAA proxy 111 in the ASN 105, may be possible.

Using the keying material of another authentication method or of another authentication connection may allow for less resources or low processing power in the G-MS 106 which can be a wireless device. Thus, the lifetime of a battery may be saved.

The G-MS 106 authenticate with the H-AAA server 112 as a standard host or as a subscriber. During this subscriber authentication of the G-MS 106 at the H-AAA server 112 first keys or first keying material is generated in the G-MS 116 and in the H-AAA server 112. The first keying material is used in order to dynamically derive the necessary RADIUS shared secret between G-MS 106 and AAA proxy 111. The subscriber authentication of the G-MS 106 with the H-AAA server 112 is based on a first authentication method, a first authentication procedure or a first authentication protocol.

As part of the subscriber authentication procedure during network attachment or network entry of the G-MS 106, the G-MS 106 and the H-AAA 112 server will generate a Master Session Key (MSK) and an Extended Master Session Key (EMSK). The EMSK is an additional keying material generated by the first authentication connection during subscriber authentication, e.g. by the EAP method. The G-MS thus may authenticate to the network NSP1, NSP2, NSP3 as a normal MS.

Since the G-MS 106 may authenticate itself as any other MS when the G-MS 106 attaches to the network using EAP, an EMSK is generated for the G-MS 106. The same EMSK is generated by both G-MS 106 and H-AAA 112. The generated EMSK is stored in the G-MS 106 and in the H-AAA 112, respectively and the EMSK will never be transferred out of the G-MS 106 and the H-AAA server 112, respectively.

Both, the G-MS 106 and H-AAA server 112 derive an additional key, a second keying material, a G-MS key or a G-MS-KEY, from the EMSK and use the derived key G-MS-KEY as a shared secret required for protecting RADIUS messages.

For example, the G-MS-KEY or the G-MS-KEY value may be derived from EMSK as in the following equation:

G-MS-KEY=HMAC_SHA1(EMSK, “g-ms keying material”)

The Hashed Message Authentication Code (HMAC) SHA1 algorithm HMAC_SHA1 is a function which takes as an input a certain number of bits and generates a substantially unique sequence of bits as a result. The input that was used to generate the result may not be reconstructed if only the result is known. The HMAC_SHA1 is a one-way function.

The lifetime of G-MS-KEY, i.e. the value of the lifetime of G-MS-KEY, is set to the lifetime of the EMSK. The lifetime of the EMSK is bound to the lifetime of the authentication session of the G-MS. That is, when the G-MS is authenticated for the first time, this authentication is valid only for some finite period of time. One way to extend the lifetime is to re-authenticate. So, the lifetime of the EMSK is determined by the H-AAA server at the time of the G-MS authentication.

Upon successful authenticating the G-MS 106 in the H-AAA server 112, the H-AAA server 112 would insert the G-MS-KEY and the lifetime of the G-MS-KEY in corresponding RADIUS attributes of a RADIUS AccessAccept message which can be sent from the H-AAA server 112 to a AAA proxy 111. An example for a format of the G-MS-KEY RADIUS attribute is shown in table Tab. 1.

TAB. 1

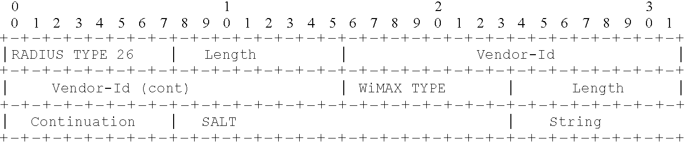

The table Tab. 1 shows in the first line a bit position from bit 0 to bit 31. The attributes are shown as fields. The length of the fields can be seen in Tab. 1 using the header line. For example the WiMAX™ Type field or type field comprises bits 16 to 23 and therefore the length is 8 bits.

The RADIUS AccessAccept message from Tab. 1 comprises the RADIUS TYPE value 26, the length field and the Vendor Id field as every standard RADIUS AccessAccept message.

Furthermore, for the G-MS-KEY RADIUS attribute the AccessAccept message comprises a WType-ID or WiMAX™ Type-ID field. The WType-ID can comprise any value which may be defined or adapted to indicate that the RADIUS AccessAccept message includes a G-MS-KEY value. The G-MS-KEY is derived during EAP authentication by the H-AAA server and passed to the NAS upon successful EAP authentication.

The length value stored in the Length field is calculated according the equation 6 octet+3 octet+2(SALT) octet+length of the String containing the encrypted G-MS-KEY in octet. An octet comprises 8 bit.

The continuation field is used, when the procedures defined in RFC 2868 are used and if the resulting encrypted string will be greater then 244 (255−11) octets then the plaintext shall be split into two attributes each encrypted separately with the C-bit of the second attribute set to 1 to indicate that this attribute is a fragment of the previous VSA. Otherwise, if no fragmentation is required, then the C-bit (the continuation field) is set to ‘0’ zero.

The value field comprises 2 octets SALT (according to RFC 2868) and String containing the encrypted MSK formulated as per RFC 2868. A SALT may be calculated according to RFC 2868.

An example of the format of the G-MS-KEY-LIFETIME RADIUS attribute is shown in table Tab. 2

TAB. 2

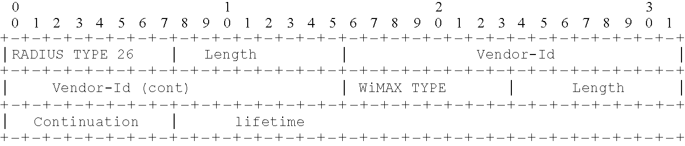

The RADIUS AccessAccept message from Tab. 2 comprises the RADIUS TYPE value 26, the length field and the Vendor Id field as every RADIUS AccessAccept message.

Furthermore, for the G-MS-KEY-LIFETIME RADIUS attribute the AccessAccept message comprises a WType-ID or WiMAX™ Type-ID field. The WType-ID can comprise any value, which differ from the value of the G-MS-KEY RADIUS attribute WType-ID. The value indicates the lifetime of the G-MS-KEY.

The length value stored in the Length field is calculated according the equation 6 octet+3 octet+4 octet.

The continuation field comprises the value C-bit=0.

The value used in the field lifetime is an unsigned 32-bit integer MSB (Most Significant Bit) first value representing the time before the key expires in seconds.

The Access Accept message is sent from the H-AAA server 112 to the authenticator of the G-MS 106. The authenticator of the G-MS 106 is located in the ASN GW 114. The authenticator gets the G-MS-KEY from the H-AAA server 112 in an Access Accept message. The authenticator of the G-MS 106 will make the G-MS-KEY available to the AAA proxy 111. Typically, the authenticator will also act as an AAA Proxy 111 for the G-MS 106, i.e. both will be collocated in the same ASN GW 114.

For transporting the values for the G-MS-KEY and the G-MS-KEY-LIFETIME an existing RADIUS message may be used.

The RADIUS protocol may also be extended with a G-MS-KEY attribute and a G-MS-KEY-LIFETIME attribute. The G-MS-KEY attribute is adapted to transport a G-MS-KEY generated by the H-AAA server 112. The G-MS-KEY-LIFETIME attribute is adapted to transport the lifetime value generated by the H-AAA server 112.

The G-MS-KEY attribute and/or the G-MS-KEY-LIFETIME attribute may be defined as WiMAX specific VSA (Vendor Specific Attribute) RADIUS attributes.

The H-AAA server 112 sends the generated G-MS key encrypted in the G-MS-KEY RADIUS attribute. As an example, the encryption is made according to RFC 2868.

The G-MS-KEY-LIFETIME attribute comprise the generated lifetime value of the G-MS-KEY expressed as the 32-bit integer MSB first, i.e. the most significant bit (MSB) is transmitted first.

When the G-MS 106 re-authenticates with the ASN 105, with the AAA proxy 111 or with the H-AAA server 112, a new MSK and EMSK may dynamically be generated. Thus, in the G-MS 106 and in the H-AAA server 112 a new value for the G-MS-KEY may be available. The new G-MS-KEY is derived based on the new authentication and the H-AAA 112 or the H-AAA server 112 transports the new G-MS-KEY value and the corresponding new lifetime value to the authenticator in a RADIUS AccessAccept message. The authenticator of the G-MS 106 is collocated with the AAA proxy 111.

In the terminology of EAP, the entity that is being authenticated is called a supplicant. The supplicant talks to the entity called authenticator, and authenticator is typically an entity to which the supplicant is connected to or which is close to the supplicant's point of attachment to the network. However, the authenticator may not really be able to authenticate the supplicant. The supplicant is authenticated by the H-AAA server 112 corresponding to the supplicant. The authenticator relays the EAP messages between the supplicant and the H-AAA server 112.

But it is the authenticator that at the end of authentication receives the AccessAccept message and based on this message give the supplicant, e.g. the G-MS 106, access to the network. When the G-MS 106 is authenticated, the authenticator role is in the ASN GW 114.

The generation of a common shared secret is compatible to the RADIUS support over EAP as described in RFC3579.

The shared secret is automatically generated within the G-MS 106 and the H-AAA server 112. Thus, the authentication method is scalable since manual pre-provisioning of keys in G-MS 106 and in the AAA proxy 111 in the ASN 105 may be prevented. Consequently, the operator may save effort and the possibility of human errors may be reduced.

An existing infrastructure, working according to the RFC3579, in particular the AAA client 113 or the RADIUS client 113 in the G-MS 106 and the AAA proxy 111, which may be employed in a WiMax™ infrastructure, can be used after introducing the method for protecting an authentication connection. In other words, the method of protecting an authentication connection may be used in an existing WiMax™ infrastructure.

FIG. 2 shows a logical network diagram with different authentication connections according to an exemplary embodiment of the present invention. FIG. 2 illustrates different steps of a method for protecting an authentication connection 201.

When the G-MS 106 in step S200 connects to the H-AAA server 112, as well in the H-AAA server 112 as in the G-MS 106 the first keying material EMSK is generated (steps S201, S202).

In step S203 the H-AAA server 112 generates the G-MS key G-MS-KEY as a second keying material.

In step S204, which may be conducted in parallel to step S203, the G-MS 106 also generates the second keying material G-MS-KEY. Thus, G-MS 106 and H-AAA 112 have the same second keying material G-MS-KEY. The lifetime of the G-MS key, which is denoted as G-MS-KEY-LIFETIME, in the G-MS 106 and in the H-AAA 112 is derived from the EMSK lifetime. The EMSK lifetime was also generated in steps S203 and S204.

In step S205 the H-AAA server sends the G-MS key and the lifetime of the G-MS key to the AAA proxy 111 in the ASN GW 114. As transport protocol the H-AAA server uses the RADIUS protocol, in particular a Message-Authenticator attribute of a RADIUS message.

After distributing the G-MS key and lifetime of the G-MS key, the G-MS 106 and AAA proxy 111 have the same second keying material, comprising the G-MS-KEY and the G-MS-KEY-LIFETIME.

Once the second keying material is received, the second keying material in step S206 can be used for establishing a second authentication connection or for conducting a second authentication method between the G-MS 106 and AAA proxy 111. In other words, an authentication connection is established between the two endpoints of the authentication connection, G-MS 106 and AAA proxy 111 respectively.

Since G-MS 106 and AAA proxy 111 have the same keying material G-MS-KEY, the G-MS 106 and the AAA proxy 111 can set up a RADIUS connection as a second authentication connection. Thus, a RADIUS method or a RADIUS protocol can be used for protecting an authentication connection between G-MS 106 and AAA proxy 111. Thus, the secured exchange of messages between these two endpoints may be possible. The security in this case comprises integrity protection and data origin authentication.

The G-MS 106 can use the RADIUS client 113 for establishing the RADIUS connection with the AAA proxy 111. The G-host 104 sends authentication messages in the EAP format to the G-MS 106. The G-MS 106 encapsulates or converts the authentication messages from the G-host 104 in RADIUS messages and sends the RADIUS messages comprising the EAP messages to the AAA proxy 111. Thus, the EAP message is carried as one field of the plurality of fields in the RADIUS message.

The AAA-proxy forwards the RADIUS messages from the G-MS 106 to the H-AAA server 112b corresponding to the G-Host 104 In addition to the RADIUS connection from the G-MS 106 to the AAA-proxy 111 an RADIUS connection exist from the AAA proxy 111 to the H-AAA 112b of the G-host.

In step S207 a G-host 104 enters the network 105 via the G-MS 106. The G-host 104 uses the EAP protocol which may commonly be used for G-host authentication. However, instead of an ASN GW, the G-MS 106 is the authenticator of the G-host 104.

The trusted connection is between the G-MS 106 and the AAA proxy 111 in the ASN 105. The AAA proxy 111 is just an intermediary and it has the security associations with the H-AAA servers 112b of the G-hosts and relay the RADIUS messages received from the G-MS 104 to the appropriate H-AAA server 112b of a G-host 104.

Thus, the first authentication method 200 or the first authentication protocol is utilized to get the first keying material EMSK and the lifetime of the EMSK. From the first keying material EMSK the shared secret G-MS-KEY and the lifetime G-MS-KEY-LIFETIME is derived. Once the shared secret or the second keying material G-MS-KEY is derived, the second keying material G-MS-KEY is utilized for the second authentication method 201. The second authentication connection 201 or the second authentication method 201 may be used for authenticating at least one of the G-hosts 104 which may connect to at least one of the plurality of interfaces 108 of the G-MS 106.

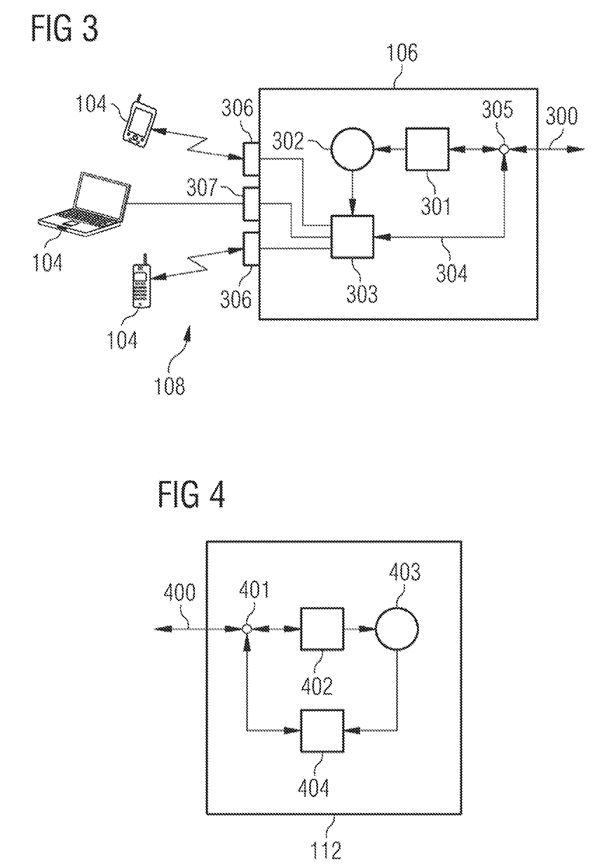

FIG. 3 shows a block diagram of a Mobile Gateway apparatus 106 according to an exemplary embodiment of the present invention.

The Mobile Gateway apparatus 106 or G-MS 106 comprises the bidirectional network interface 300 for connecting the G-MS to a network (not shown in FIG. 3). The interface 300 is connected to the Authenticating device 301 which can be used, for establishing a first authentication connection by conducting a first authentication method.

This first authentication method allows the Keying Material Generating device 302 to derive a second keying material.

This second keying material is used in the second Authentication device 303 for establishing a second authentication connection via the internal bidirectional link 304 which is coupled via transceiver 305 to the network interface 300.

The second authentication device 303 allows identifying hosts 104 which are connected via the plurality of interfaces 108, e.g. via the wireless interfaces 306 or the wired interface 307 to the second Authentication device 303. The wireless interfaces may base on at least one of the IEEE 802.16, the IEEE 802.16e, the WiMax™ standard and the wired interface 307 may base on the IEEE 802.3 standard. Other interface protocols like Bluetooth, GSM (Global System for Mobile Communication), UMTS (Universal Mobile Telecommunications System) or LTE (Long Term Evolution) are also possible.

FIG. 4 shows a block diagram of a Master apparatus 112 according to an exemplary embodiment of the present invention.

The Master apparatus 112 or H-AAA server 112 has the bidirectional network interface 400 for connecting the H-AAA server 112 to a network, e.g. to an ASN (not shown in FIG. 4). Via the network interface 400 and the transceiver 401 the Authenticating device 402 receives a first authentication connection. The first authentication connection may be established by using a first authentication method.

During establishing of the first authentication connection the Authenticating device 402 generates a first keying material, which the Authenticating device 402 provides to the Keying Material Generating device 403. The Keying Material Generating device derives a second keying material from the first keying material.

The Keying Material Generating device 403 provides the second keying material to the Keying Forwarding device 404, which sends the second keying material via network interface 400 to a AAA proxy (not shown in FIG. 4). The Keying Forwarding device 404 may generate a RADIUS AccessAccept message for forwarding the second keying material to the AAA-proxy.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### ACRONYMS AND TERMINOLOGY

AAA Authentication, Authorization and Accounting
AR Access Router
ASN WiMAX™ Access Serving Network
ASNGW Access Serving Network Gateway
BAck MIP6 Binding Acknowledge message
BS WiMAX™ Base Station
BU MIP6 Binding Update message
CMIP Client Mobile IP (as opposed to PMIP)
CoA MIP6 Care-of Address
CSN WiMAX™ Connectivity Serving Network
DHCP Dynamic Host Configuration Protocol
DHCP Dynamic Host Configuration Protocol
EAP Extensible Authentication Method
FA Foreign Agent
FQDN Fully Qualified Domain Name
G-host end user device connected to the network via G-MS
G-MS Gateway MS
HA Home agent
H-AAA Home AAA server (located in the home network of the WiMAX™ subscriber)
host IPv6 node
Host same as G-host
IANA Internet Assigned Numbers Authority
LMA Local Mobility Anchor
MAG Mobility Access Gateway
MIP Mobile IP
MN Mobile Node
MS Wi MAX Mobile Station
NAI Network Access Identifier
NAP WiMAX™ Access Network Provider (operator of an ASN)
net1 mm Network localized mobility management
NSP WiMAX™ Network Service Provider (operator of a CSN)
PBAck PMIP6 Proxy Binding Acknowledge message
PBU PMIP6 Proxy Binding Update message
PMIP Proxy Mobile IP
PMIP Proxy Mobile IP
PMIP4 Proxy Mobile IP version 4
Proxy Mobile IPv6
RAN Radio Access Network
SA Security Association
V-AM visited AM server (located in the visited network)
VSA Vendor Specific Attribute

What is claimed is:

1. A method for protecting an authentication connection, comprising:
generating a first keying material by generating a first authentication connection;
deriving from the generated first keying material a second keying material;
utilizing the second keying material for protecting a second authentication connection.

2. The method of claim 1, wherein deriving is dynamically deriving the second keying material.

3. The method of claim 1, wherein the first authentication connection bases on the Extensible Authentication Protocol.

4. The method of claim 1, wherein the second authentication connection is an Remote Authentication Dial In User Service connection.

5. The method of claim 1, wherein generating a first keying material comprises generating the first keying material in a Mobile Gateway apparatus and/or in a Master apparatus.

6. The method of claim 1, wherein generating a first keying material comprises generating a Master Session Key and/or an Extended Master Session Key.

7. The method of claims 1, wherein generating a second keying material comprises calculating a shared secret in a Mobile Gateway apparatus and/or in a Master apparatus.

8. The method of claims 1, further comprising providing the second keying material to a Proxy Relay apparatus.

9. A method for generating a keying material in a Mobile Gateway apparatus, comprising:
authenticating the Mobile Gateway apparatus at a Master apparatus by generating a first authentication connection;
generating a first keying material during authenticating;
deriving a second keying material from the first keying material;
utilizing the second keying material for a second authentication connection.

10. A method for generating a keying material in a Master apparatus, comprising:
authenticating a Mobile Gateway apparatus in the Master apparatus by generating a first authentication connection;
generating a first keying material during authenticating;
deriving from the first keying material a second keying material;
utilizing the second keying material in a second authentication connection.

11. The method of claim 10, further comprising:
providing the second keying material to a Proxy Relay apparatus.

12. A computer-readable medium, comprising program code, which when being executed by a computer carries out:
Generating a first keying material by generating a first authentication connection;
Deriving from the generated keying material a second keying material;
Utilizing the second keying material for protecting a second authentication connection.

13. A communication system comprising:
a Mobile Gateway apparatus;
a Master apparatus;
wherein the Mobile Gateway apparatus and the Master apparatus are adapted for generating a first keying material by generating a first authentication connection;
deriving from the generated keying material a second keying material;
utilizing the second keying material for protecting a second authentication connection.

14. A Mobile Gateway apparatus, comprising:
a first Authentication device for authenticating the Mobile Gateway apparatus with a Master apparatus by generating a first keying Material by generating a first authentication connection;
a Keying Material Generation device for deriving a second keying material from the first keying material;
a second Authentication device for utilizing the second keying material for a second authentication connection.

15. A Master apparatus, comprising:
an Authenticating device for authenticating a Mobile Gateway apparatus;
a Keying Material Generating device for utilizing a first keying material of the first authentication method for deriving a second keying material.
